(19) United States
(12) Patent Application Publication
(10) Pub. No.: US 2009/0165661 A1
(43) Pub. Date: Jul. 2, 2009

(54) Method and Device for Printing Solar Cells By Screen Printing

(75) Inventors: Ewald KOENIG, Wyhl (DE); Markus HILPERT, Gundelfingen (DE); Klaus MESSMER, March-Holzhausen (DE)

Correspondence Address: CROWELL & MORING LLP;INTELLECTUAL PROPERTY GROUP, P.O. BOX 14300, WASHINGTON, DC, 20044-4300, US

(73) Assignee: THIEME GmbH & Co. KG, Teningen (DE)

(21) Appl. No.: 12/134,539

(22) Filed: Jun. 6, 2008

(30) Foreign Application Priority Data
Jun. 6, 2007 (DE) 10 2007 026 978.3

(51) Int. Cl. B41M 1/12

(52) U.S. Cl. 101/129

(57) ABSTRACT

A method and device for printing solar cells by screen printing is provided. During the pressure movement of the doctor blade, the printing screen is raised at the end thereof which at the rear with respect to the doctor blade movement direction during printing in order to maintain a screen release angle between the screen and the solar cell behind the doctor blade above a critical value. The method and device may be used for printing surface contacts or flat coatings on solar cells.

### CROSS-REFERENCE TO RELATED APPLICATION

This application claims the priority of German Application No. 10 2007 032 987.3, filed Jun. 6, 2007, the disclosure of which is expressly incorporated by reference herein.

### BACKGROUND AND SUMMARY OF THE INVENTION

The invention relates to a method for printing solar cells by screen printing. The invention also relates to a device for printing solar cells by screen printing.

For printing solar cells by screen printing, specifically for the application of surface contacts or so-called finger contacts, use is made of thick film printers, which were originally developed for printing solder deposits in surface mounted devices (SMDs). Such thick film printers have very strong screen frames in order to ensure the necessary printing precision and operate with very high screen tensions or with fixed, glazed stencils. As the screen tensions are very high, a pressure doctor blade can only slightly press into the screen during printing, so that it is necessary to work with very limited spacings between the printing screen and the solar cell to be printed. The high screen tension also makes it necessary to have very rigid doctor blades. In the perfect state known thick film printers operate in a highly precise manner, but the necessary highly tensioned printing screens must be equipped with very expensive, strong frames and the known thick film printers are also comparatively sensitive to fluctuations in process parameters, e.g. relative to fluctuations of the contact pressure of the doctor blade or variations in the parallelism between the top and bottom of the solar cell. A prior art thick film printer and a printing screen for the same are shown in FIGS. 1a and 1b.

The problem of the invention is to provide a device and a method for the screen printing of solar cells, which is suitable for quantity production and which reacts insensitively to process parameter changes.

For this purpose the invention provides a method for printing solar cells by screen printing, in which during a doctor blade pressure movement a printing screen is raised at the rear end of the screen when considered relative to a movement direction of the doctor blade during printing, in order to maintain a release angle of the screen between the latter and the solar cells behind the doctor blade above a critical value.

The invention is based on the surprising finding that the known thick film screen printing processes originally developed for printing solder deposits in the SMD sector, are admittedly suitable, but extensively overdimensioned for the printing of solar cells. The thick film printers are dimensioned for high forces in the printing screen and thick films and with respect to the attainable printing precision correspond to SMD technology requirements. However, when printing solar cells other marginal conditions are decisive. A disadvantage of the known thick film screen printing processes are that they are very sensitive to the smallest variations in the screen printing parameters and these e.g. include the thickness of the solar cell to be printed, the parallelism of the surface to be printed relative to the printing screen and surface unevennesses of the solar cell. However, the inventive method is tolerant to screen printing parameter changes and also in the case of uneven, varyingly high solar cells are solar cells with surfaces to be printed which are not precisely parallel to the printing screen, it is still possible to achieve a satisfactory and adequately precise print image. As one side of the printing screen is raised at the rear end during printing, the release angle of the screen between the latter and the just printed solar cell is kept above a critical value and it is possible to ensure that the printing screen can be rapidly released from the printing paste or ink just applied to the solar cell. This rapid release of the printing screen from the printing paste which has just been applied increases the printing quality with respect to the definition of contours to a significant extent and it is consequently possible to e.g. work with screens tensioned to a comparatively low extent and very soft doctor blades, which permits the compensation of unevennesses or the lack of parallelism between the solar cells. In addition, the loading of the just printed solar cell by the doctor blade can be kept very low, so that the fracture rate can be kept very low even with sensitive solar cells, e.g. so-called string-ribbon wafers. The rapid printing screen release behind the doctor blade, in that the release angle is kept above a critical value, makes the inventive method insensitive to variations in screen printing parameters and consequently allows a so-called multiple usage, in which several juxtaposed solar cells are simultaneously printed with one printing screen. Thus, the invention leads to low forces on the wafer, a very good printing quantity and a low fracture risk. The inventive method is suitable for printing surface contacts or flat coatings on solar cells.

In a further development of the invention the screen release angle during the doctor blade pressure movement is kept at a value of more than 0.8ø.

It has been found that during the printing of solar cells, e.g. with surface contacts, a release angle of more than 0.8ø favours a rapid printing screen release from the conductive printing paste and therefore a precise print image. The sought release angle of more than 0.8ø is achieved at the start of the doctor blade printing movement with the printing screen frame and solar cell still parallel. During the doctor blade movement over the just printed solar cell the release angle behind the doctor blade would otherwise necessarily become more shallow and this is compensated by an appropriate raising of the rear end of the printing screen frame.

In a further development of the invention the release angle during the entire doctor blade pressure movement is kept at a value between 0.8ø and 1.2ø.

It has been found that a release angle variation between 0.8 and 1.2ø can be tolerated and leads to good printing results.

In a further development of the invention throughout the doctor blade pressure movement the release angle is kept at a constant value.

By maintaining the release angle at a constant value, throughout the doctor blade pressure movement and therefore over the entire surface of the just printed solar cells identical conditions can be obtained behind the doctor blade, because in the case of a constant doctor blade speed the printing screen is always released at the same speed and under the same angle from the just applied printing paste. Consequently it is possible to ensure a uniformly precise print image over the entire solar cell surface and a maximum process window of the screen printing parameters, i.e. a range in which the screen parameters can be positioned, without compromising the faultless printing process sequence.

In a further development of the invention the printing screen is so raised that a screen angle between the printing screen and the just printed solar cell is raised from approximately 0ø to approximately 0.5ø, the printing screen being pivotably mounted at its front end with respect to the doctor blade movement direction during printing about a fulcrum. At a distance of approximately 650 to 710 mm from the fulcrum, the printing screen can e.g. be raised during the doctor blade pressure movement between 0 and 5 mm per 200 mm doctor blade path. With a printing screen format of 600 mm×700 mm, which is appropriate for printing standard solar cell sizes, precise print images can be obtained as a result of the indicated measures. This more particularly applies if with said printing screen size there is a simultaneous printing of two solar cells, i.e. a so-called double usage is achieved.

In a further development of the invention a screen spacing of the printing screen on all sides is set at a value of at least 150 mm.

The so-called screen spacing indicates the distance between a print image on the printing screen to the inner edge of the screen frame. Ultimately the screen spacing represents an unused area of the screen. Thus, a large screen spacing leads to a soft screen, because at a greater distance from the printing screen frame the screen can be more easily pressed towards the solar cell to be printed than in the immediate vicinity of the printing screen frame. A screen spacing increase conventionally leads to a reduction in the attainable precision during printing, because necessarily with a greater distance from the printing screen frame greater length tolerances can arise during the pressing down of the screen. This is e.g. the reason why conventional thick film printers during the printing of solar cells operate with very small screen spacings and highly tensioned screens. It has surprisingly been found that a screen spacing increase allows a lower doctor blade pressure, which in turn allows a lower loading of the just printed solar cell wafer, without the print precision arriving in ranges unsuitable for printing solar cells. This significantly reduces the fracture risk when printing solar cells, particularly those cells having divergences in the parallelism between the top and bottom sides and with unevennesses in the just printed top side.

In a further development of the invention a printing screen tension is set at a value equal to or lower than 25 N/cm.

Such a low screen tension compared with conventional thick film printers for solar cells makes it possible to work with soft pressure doctor blades and low doctor blade forces with which the doctor blade is pressed against the printing screen and the just printed solar cell. Due to the comparatively low screen tension, the printing screen, under the doctor blade contact pressure on the surface unevennesses, can adapt to the just printed solar cell, although only a comparatively low doctor blade force has to be applied. This also makes it possible to print uneven, highly sensitive solar cells, so-called string-ribbon wafers, in a precise manner and with a very limited fracture rate.

In a further development of the invention the doctor blade angularity is adapted to a surface slope of the solar cell during printing, the doctor blade being connected by at least two pressure cylinders to a doctor blade carrier and in which the angularity of the doctor blade is adjustable around the longitudinal direction of the blade movement during printing.

Through the angularity of the doctor blade being adapted to the surface slope of the solar cell during printing, precise printing can even be ensured for solar cells whose surface to be printed is not entirely parallel to the printing screen, in that the doctor blade and wafer surface are always kept parallel. By adapting the doctor blade angularity a uniform loading of such non-parallel solar cells is also ensured. If the doctor blade angularity was not adapted, in the area of the solar cell closer to the printing screen a very high loading would necessarily occur and there would be a very high probability of the solar cell fracturing or breaking during printing. These risks can be avoided with the inventive method.

In a further development of the invention, a doctor blade force with which the doctor blade is pressed during printing against the printing screen and the substrate, is set at a value between 2 and 10 N/cm doctor blade length, particularly 5 N/cm.

In conjunction with a low screen tension and a high screen spacing, doctor blade forces between 2 and 10 N/cm doctor blade length are sufficient for bringing about an adequate doctor blade contact pressure. However, the loading of the just printed solar cell by the doctor blade force can be kept very low and the fracture risk drops considerably.

The problem of the invention is solved by a solar cell printing device using screen printing, in which a printing screen is pivotably mounted at a front end of the doctor blade considered in the doctor blade movement direction during printing and in which a device for raising the rear end of the printing screen during the doctor blade pressure movement is provided, a doctor blade carrier and at least two pressure cylinders being provided for connecting the doctor blade to the doctor blade carrier, and in which the doctor blade is pivotably fixed to the pressure cylinders about a longitudinal direction of the doctor blade movement during printing and in which the pressure cylinders and/or a control of the action of the pressure cylinders is so dimensioned that a change in the pressure acting on the pressure cylinders of one bar leads to a change in the doctor blade force of max 2.5 N/cm, particularly 1.8 N/cm.

Consequently the inventive device is insensitive to fluctuations in the hydraulic or pneumatic pressure with which the pressure cylinders press the doctor blade against the printing screen and the printed solar cell. Fluctuations in the pressure acting on the pressure cylinders consequently only lead to a minor change to the doctor blade force per doctor blade length, so that even with pressure fluctuations there is no increased fracture risk of the just printed solar cell. Such a pressure cylinder design can e.g. be achieved by reducing the hydraulically active pressure cylinder cross-section. As a result the inventive device is tolerant to faults and allows the printing of solar cells with a low fracture rate even with large scale production. A control cam or servomotor can e.g. be used for raising the printing screen. The doctor blade force per doctor blade length, also referred to as the doctor blade pressure, and the pressure acting on the pressure cylinders consequently have a wide process window, which makes it possible to significantly increase the reliability of the printing process.

In a further development of the invention, the doctor blade is made from a flexible material strip of a rubbery material with a Shore hardness of less than 65 and which is inclined relative to the printing screen.

As a result of the high screen tensions, conventional thick film printers when printing solar cells operate with strong screen frames and consequently also with hard or rigid doctor blades, which are sufficiently stable to displace the highly tensioned printing screen and press the same against the solar cell to be printed. Thus, conventional thick film printers use a so-called diamond doctor blade, in which a cross-sectionally square profile has its tip directed against the printing screen. Thus, such a diamond doctor blade is only elastically resilient to a very limited extent and can therefore only compensate to a slight extent surface unevennesses of the just printed solar cell. According to the invention a flexible material strip is inclined relative to the printing screen, so that as a result of this geometrical arrangement there is a high doctor blade flexibility. In addition, a rubbery material with a low Shore hardness is chosen, so that the blade edge can adequately follow unevennesses of the just printed solar cell and can compensate the same. In conjunction with a comparatively low screen tension, said printing screen is able to adapt under the doctor blade pressure to the surface unevennesses of the just printed solar cell, so that a satisfactory print image can be obtained.

In a further development of the invention a screen spacing of the printing screen on all sides is at least 150 mm and a printing screen tension is made equal to or lower than 25 N/cm.

### BRIEF DESCRIPTION OF THE DRAWINGS

Further features and advantages of the invention can be gathered from the claims and the following description of preferred embodiments of the invention in conjunction with the drawings. Individual features of the embodiments described and shown can be combined in a random manner without passing beyond the scope of the invention. In the drawings show:

FIG. 1a is a diagrammatic representation of a thick film printer when printing solar cells according to the prior art;

FIG. 1b is a diagrammatic representation of a printing screen for the thick film printer of FIG. 1a;

FIG. 2a is a diagrammatic side view of an inventive device for printing solar cells by screen printing;

FIG. 2b is a printing screen for the device of FIG. 2a;

FIG. 3 is another diagrammatic side view of the device of FIG. 2a;

FIG. 4 is another diagrammatic side view of the device of FIG. 2a;

FIG. 5 is a diagrammatic view of the device of FIG. 2a from the front, i.e. counter to the doctor blade movement direction during printing; and

FIG. 6 is a side view of the device of FIG. 2a for illustrating certain important angles in the case of the invention.

### DETAILED DESCRIPTION OF THE DRAWINGS

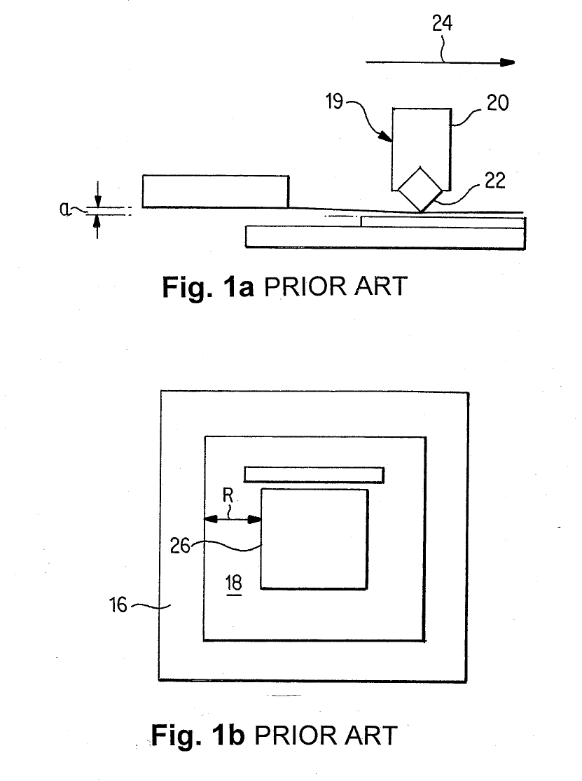

FIG. 1a shows a conventional thick film printer 10 for printing solar cells. The thick film printer 10 has a print rest 12 on which rests a solar cell 14 to be printed. Parallel to the print rest is held a printing screen frame 16, to which is fixed in the tensioned state a printing screen 18. A printing doctor blade 19 has a doctor blade holder 20 and a blade rubber 22. During printing, the doctor blade 19 is pressed against the printing screen 18 in the direction of solar cell 14 and moves in the direction of arrow 24 over the solar cell surface. For this purpose it is necessary to overcome a distance “a” between the printing screen in the planar state and the surface of the solar cell 14 to be printed (this is also referred to as the screen printing form distance or jump-off). The conventional thick film printer 10 operates with very high screen tensions, a very strong, stable screen frame 16, very rigid or hard doctor blades 19 and a very low form distance a. Due to the high screen tensions the force to be applied by the doctor blade to overcome the distance a is comparatively high. Thus, the doctor blade rubber 22 must be made from elastic material with a high Shore hardness to ensure that the edge of the doctor blade rubber 22 pressed against the screen does not stand up with such a large surface area on the screen that exact printing is rendered impossible. In addition, the cross-sectional shape of the blade rubber 22 is square, so that as a result of this shaping and the arrangement as a square stood on an edge the blade rubber 22 is relatively inflexible.

FIG. 1b shows in a diagrammatic view from above the screen frame 16 and printing screen 18. An area 26 of printing screen 18 is the area in which the print image is applied to solar cell 14. A distance between the outer edge of area 26 and the inner edge of screen frame 16 is called the screen spacing R. To ensure a high printing precision, during print screening with conventional thick film printers operation takes place with small screen spacings R. Reference numeral 16a indicates the very strong, large cross-section of screen frame 16.

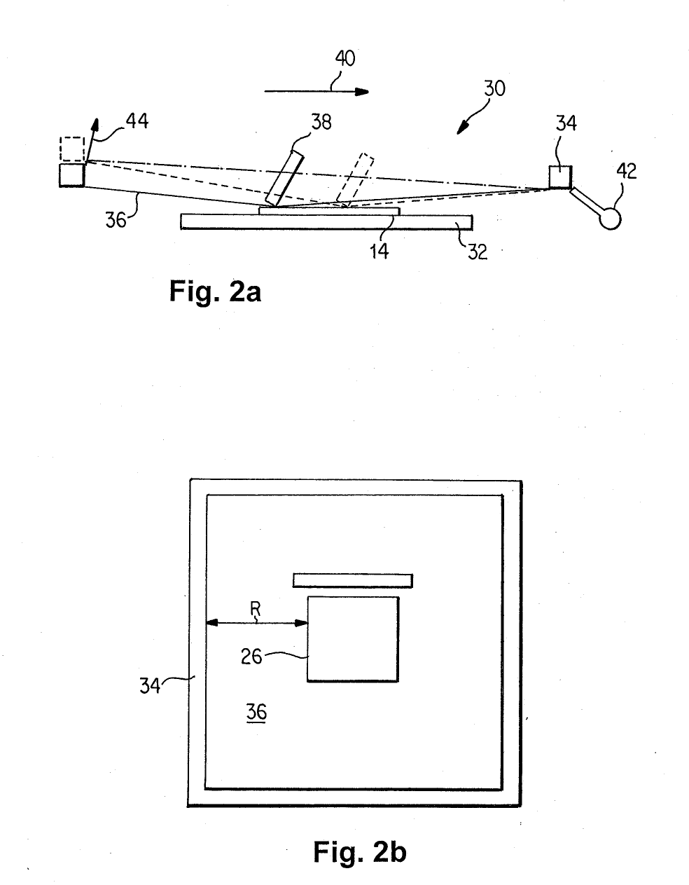

The diagrammatic side view of FIG. 2a shows an inventive device 30 for the screen printing of solar cell 14. Device 30 has a print rest 32 on which the solar cell 14 rests. A screen frame 34 tensions a printing screen 36 and during printing a doctor blade 38 is pressed against screen 36 and solar cell 14 and then moves in the direction of arrow 40 over the surface of solar cell 14 to be printed. With respect to the printing screen 36, the doctor blade 38 has an inclined flexible material strip of elastic material. So as not to overburden representation in FIG. 2, a doctor blade holder in which the material strip is fixed is not shown.

On comparing doctor blade 38 of FIG. 2a with the doctor blade of the thick film printer of FIG. 1a, it becomes clear that as a result of the shape of doctor blade 38 as an elongated material strip it has a much higher flexibility than the doctor blade of the thick film printer of FIG. 1a. Moreover, a rubbery material with a Shore hardness below 65 is chosen for the doctor blade 38 in the inventive device. Thus, doctor blade 38 can readily adapt to surface unevennesses of solar cell 14.

At its front end in the movement direction 40 of doctor blade 38 during printing, screen frame 34 is pivotably mounted on a fulcrum 42. Therefore the screen frame can be upwardly pivoted by its rear end along an arrow 44 and e.g. assume the broken line position shown in FIG. 2a.

Doctor blade 38 is shown in two different positions in FIG. 2a, in continuous line form roughly at the start of the pressure movement and in broken line form roughly at two thirds of the pressure movement over solar cell 14. In continuous line form is represented the position of the printing screen 36 in the continuous line form of doctor blade 38. In broken line form is shown the position of the printing screen 36 assumed when the doctor blade 38 is in its broken line position and the screen frame 34 is in its one-sided raised position using the screen lift. A dot-dash line indicates an imaginary position of printing screen 36 when the screen frame 34 is in the upwardly pivoted position.

During the pressure movement of doctor blade 38 over the surface of solar cell 14 the rear end of frame 34 is raised along arrow 44. Thus, considered in the direction of arrow 40, behind the doctor blade the printing screen 36 is more rapidly released from the surface of solar cell 14. Specifically a release angle formed by the portion of the printing screen behind doctor blade 38 with the surface of solar cell 14 is higher for a given doctor blade position than when printing screen 34 was not pivoted upwards during the pressure movement of doctor blade 38. Without the lifting of the printing screen the release angle would become smaller with an increasing doctor blade path. This raising of the printing screen 34 in the vicinity of its rear end, in the case of the inventive device ensures that the printing screen 36 behind the doctor blade rapidly lifts from the surface of solar cell 14 and therefore also rapidly from the printing paste pressed through the printing screen 36 by doctor blade 38 and located on solar cell 14 behind blade 38. Thus, throughout the pressure movement of doctor blade 38 over the surface of solar cell 14 a precise print image can be obtained, because also at the end of the pressure movement of blade 38 the printing screen 36 is rapidly moved out of the printing paste applied in that the release angle is kept above a predetermined value or at a constant value.

Compared with the conventional thick film printer of FIG. 1a, FIG. 2b shows that the printing screen frame 34 has a much smaller cross-section 34a than the cross-section 16a of the screen frame 16 of printer 10. The inventively used screen tensions are significantly lower than with conventional thick film printers, so that lightly constructed screen frames 34 can be used. What is important compared with conventional thick film printers is not the absolute cross-sectional dimensions, but instead the ratio of the screen frame cross-section to the screen frame size, which with the conventional thick film printer is much higher than with the inventive device.

Compared with the thick film printer of FIG. 1a, it is pointed out that the printing screen frame 34 is much larger than the printing screen frame 16 of FIGS. 1a and 1b. In particular, the screen spacing R between area 26 of printing screen 36 having the print image and the inside of screen frame 34 is much larger than for the printing screen of FIG. 1b. Specifically, the screen spacing R in the inventive device is at least 150 mm on all sides. Therefore, the area 26 with the print image of printing screen 36 can be moved much more easily in the direction of the solar cell 14 than with the printing screen of FIG. 1b. This is because the screen spacing R is larger and also a screen tension of 25 N/cm or less is chosen. Consequently, with the invention much lower doctor blade forces can be chosen.

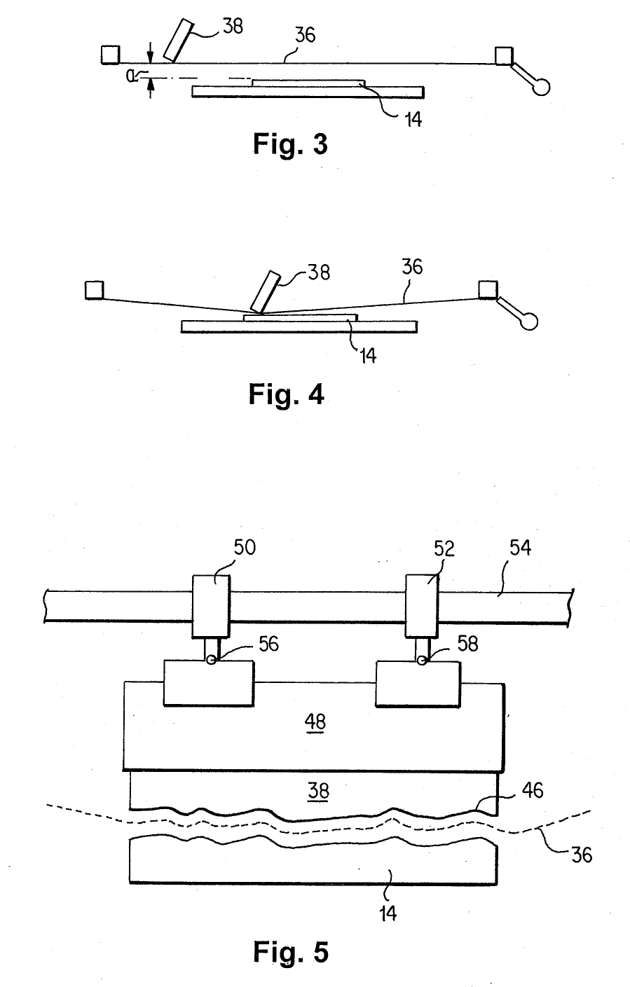

FIGS. 3 and 4 show the device of FIG. 2a in two different positions. FIG. 3 shows the inventive device 30 before printing starts and the printing screen 36 is oriented parallel to the surface of solar cell 14 to be printed. As stated, the distance between printing screen 36 and the solar cell surface to be printed is called the form distance or jump-off a. Compared with the conventional thick film printer 10 of FIG. 1a, the form distance is much greater, e.g. 4 mm. In the state of FIG. 3 the doctor blade 38 is in contact with printing screen 36, but does not yet press it downwards towards solar cell 14.

The state diagrammatically illustrated in FIG. 4 shows the start of printing on solar cell 14. The doctor blade 38 presses the printing screen 36 downwards until screen 36 contacts solar cell 14. Subsequently the doctor blade 38 is moved to the right in FIG. 4 over the surface cell 14 to be printed.

The diagrammatic representation of FIG. 5 shows a front view of the inventive device 30 of FIG. 2a, i.e. counter to arrow 40. It can be see that the solar cell 14 to be printed has an uneven surface. The printing screen 36, which is shown at a certain distance over the surface of solar cell 14 to be printed to facilitate understanding, as a result of the selected low screen tension and high screen spacing, under the pressure of doctor blade 38 in the vicinity of its edge 46 the printing screen is able to adapt to surface unevennesses of solar cell 14. Due to the low hardness of max 65 Shore and the selected doctor blade shape, the doctor blade 38 is once again sufficiently elastic for its edge 46 to follow the surface configuration of the solar cell 14 and consequently there is a continuous linear contact between printing screen 36 and the surface of solar cell 14.

Doctor blade 38 is held by a blade holder 48, which is fixed to a doctor blade carrier 54 by two pressure cylinders 50, 52. By means of not shown pressure lines, pressure cylinders 50, 52 are e.g. supplied with compressed air and lead to the doctor blade 38 being pressed against printing screen 36 and solar cell 14. The doctor blade carrier 54 is laterally movable along not shown rails, i.e. in FIG. 5 into and out of the drawing plane. Piston rods of pressure cylinders 50, 52 are pivotably fixed to the doctor blade holder 48 by joints 56, 58.

Thus, the pressure doctor blade 38 can change its angularity relative to the doctor blade carrier 54, so that the blade holder 48 is instead of being parallel now at an angle to the carrier 54. This change in the angularity of the doctor blade 38 takes place automatically on placing on solar cell 14. If the surface of solar cell 14 to be printed is inclined to the doctor blade carrier 54, the doctor blade 38 is automatically set parallel to the surface of solar cell 14 to be printed. As both pressure cylinders 50, 52 receive the same pressure, a constant contact force, the so-called doctor blade force is obtained over the length of blade edge 46.

To be able to easily bring about adaptation to different doctor blade lengths, the pressure cylinders 50, 52 are adjustable along doctor blade carrier 54 and are secured thereon solely by clamping screws. Not shown clamping screws or clamping levers are also provided, so that the doctor blade holder 48 can be rapidly fixed without tools to the pressure cylinders 50, 52.

The pressure cylinders 50, 52 are so dimensioned that a change to the pressure applied only leads to a slight change to the doctor blade force with which the doctor blade 38 is pressed against printing screen 36 and solar cell 14. The pressure cylinders are so designed that in the case of a one bar change to the pressure applied to the pressure cylinders 50, 52, there is a change to the doctor blade force of max 2.5 N/cm and specifically 1.8 N/cm. This is brought about by reducing the cylinder bores of the pressure cylinders, which e.g. only have a diameter of 20 or 12 mm.

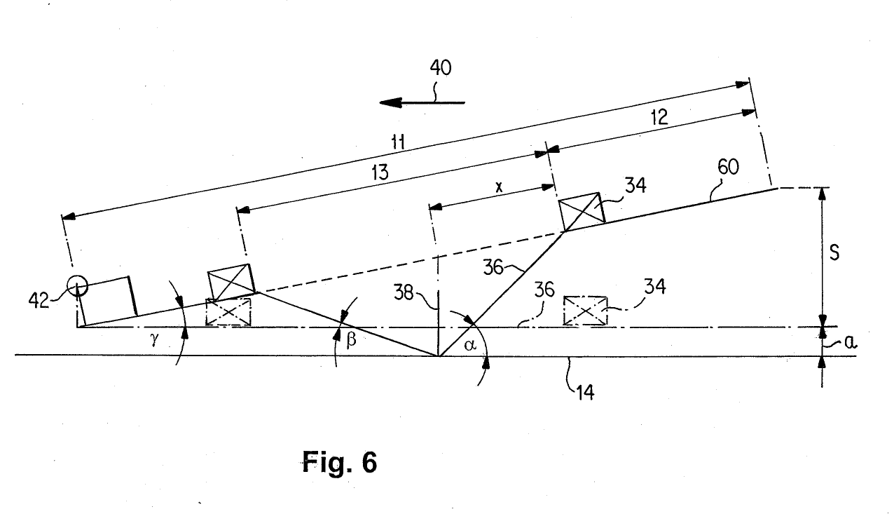

FIG. 6 shows the inventive device 30 of FIG. 2a in a further diagrammatic representation and to illustrate the angular ratios of the inventive device a tilted position of the screen frame 34 is shown in greatly exaggerated form. Compared with FIG. 2a, the fulcrum 42 therein is at the right and in FIG. 6 at the left. The screen frame 34 with the printing screen 36 is pivotably articulated about fulcrum 42. In continuous line form the screen frame 34 is shown in a pivoted position with its rear end raised. In broken line form is shown a position of screen frame 34 in which the printing screen 36 is parallel to the surface of solar cell 14 to be printed. During printing, doctor blade 38 moves in the direction of arrow 40, i.e. to the left in FIG. 6. A release angle formed by printing screen 36 with the just printed surface of solar cell 14 behind doctor blade 38 is, according to the invention, kept above a critical value. It has proved to be advantageous to keep the release angle throughout the printing process above 0.8ø and specifically constant at approximately 1ø. An angle formed by the printing screen 36 with the surface of solar cell 14 still to be printed and upstream of doctor blade 38 rises during printing and in an implemented embodiment from approximately 0.3ø to approximately 1ø. An angle by which the printing screen frame 34 is pivoted starting from a broken line position into the continuous line position is 0ø at the start of the printing process and then rises to approximately 0.5ø.

A length S designates the so-called screen lift in mm, i.e. the length by which the printing screen frame 34 is raised at the end of an extension 60. The distance a, i.e. the screen printing form distance or jump-off, can in the represented, preferred embodiment be between 2 and 5 mm. The screen lift S is to be considered in conjunction with the path covered by doctor blade 38 during the printing process. In the embodiment shown the extension 60 of printing screen 34 is raised by 4.2 mm/200 mm of doctor blade path and the screen lift is set between 0 mm/200 mm and 5 mm/200 mm of doctor blade path.

Length L1 designates the spacing of the application point of a not shown device for lifting the screen frame 34 at extension 60. In the embodiment shown length L1 is 689 mm. Length L2 designates the spacing of the rear inner edge of screen frame 34 from the application point of the screen lift device. In the embodiment shown L2 is 85 mm. L3 is the screen length, i.e. the distance from the rear inner edge of screen frame 34 to the front inner edge of the screen frame. In the embodiment shown length L3 is 520 mm. X designates the position of doctor blade 38. At the start of the printing process the distance X of the doctor blade from the rear inner edge of screen frame 34 is 108 mm and at the end of the printing process it is 362 mm.

In the embodiment shown it is made possible by the raising of the printing screen frame 34 to keep the release angle constant at a value of approximately 1ø throughout the printing process.

The invention provides a solar cell screen printing method and device characterized by a high tolerance with respect to changes to the screen printing parameters. The screen printing parameters e.g. include the form distance or jump-off a, which as a result of unevennesses of the solar cells to be printed or thickness differences of the solar cells to be printed can diverge from a desired value. Another screen printing parameter is the evennesses or flatness of the surface to be printed. Specifically in the case of string-ribbon wafers, which are characterized by a highly uneven surface, the inventive method and device can bring about very good results. String-ribbon wafer solar cells are also extremely fracture-sensitive and once again the invention leads to very good results. The low screen tension, large screen spacing, the flexibly suspended, soft doctor blade rubber and in particular the one-sided raising of the rear end of the printing screen during the printing process make it possible to achieve a very good printing quality and at the same time a very low loading of the printed solar cells. The fracture rate when using the inventive method is consequently extremely low and the down times which necessarily arise when wafer fragments have to be removed from the printing screen or the print rest can be kept low. The doctor blade force with which the doctor blade is pressed against the printing screen and solar cell is very low and is only subject to very limited fluctuations and consequently the inventive method and device can be very readily used. The pivotable suspension of the doctor blade about a longitudinal direction of the doctor blade movement during printing also makes it possible to easily compensate divergences from the parallelism between the surface to be printed and the printing screen. The provision of at least two pressure cylinders for applying the doctor blade force simultaneously ensures that inclined surfaces are subject to a constant doctor blade force over the entire doctor blade width.

The foregoing disclosure has been set forth merely to illustrate one or more embodiments of the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for printing solar cells via screen printing, the method comprising the acts of:
during printing, raising a printing screen during a pressure movement of a doctor blade at a rear end of the printing screen relative to a movement direction of a doctor blade; and
maintaining, by the raising act, a release angle (a) of the printing screen between the printing screen and a printing screen solar cell behind the doctor blade above a critical value.

2. The method according to claim 1, wherein the release angle (α) of the printing screen is maintained at a value of more than 0.8° throughout the pressure movement of the doctor blade.

3. The method according to claim 2, wherein the release angle (α) is maintained throughout the pressure movement of doctor blade at a value between 0.8° and 1.2°.

4. The method according to claim 1, wherein the release angle (α) is maintained throughout the pressure movement of doctor blade at a constant value.

5. The method according to claim 1, wherein the printing screen is raised so that a screen angle (γ) between the printing screen and a just printed solar cell is raised during printing from approximately 0° to approximately 0.5°, the front end of the printing screen, considered relative to movement direction of doctor blade during printing, being pivotably mounted about a fulcrum.

6. The method according to claim 5, wherein, at a distance of approximately 650 mm to 710 mm from the fulcrum during printing, the printing screen is raised between 0 and 5 mm/200 mm of doctor blade path.

7. The method according to claim 1, wherein a screen spacing of the printing screen is set at a value of at least 150 mm on all sides.

8. The method according to claim 1, wherein a screen tension of the printing screen is set to a value equal to or below 25 N/cm.

9. The method according to claim 7, wherein a screen tension of the printing screen is set to a value equal to or below 25 N/cm.

10. The method according to claim 1, wherein the angularity of the doctor blade to a surface slope of the solar cell is adapted during printing, the doctor blade being connected by at least two pressure cylinders to a doctor blade carrier, in which carrier an angularity of doctor blade is adjustable about the longitudinal direction of the movement direction of the doctor blade during printing.

11. The method according to claim 1, wherein a doctor blade force with which the doctor blade is pressed against the printing screen and the solar cell during printing is set to a value between 2 and 10 N/cm doctor blade length.

12. The method according to claim 11, wherein the doctor blade force is set to 5 N/cm.

13. A device for screen printing of solar cells, comprising:
a printing screen pivotably mounted at a front end of a doctor blade, considered in a movement direction of the doctor blade during printing;
a device for raising the rear end of the printing screen during the printing movement of the doctor blade;
a doctor blade carrier and at least two pressure cylinders for connecting the doctor blade to the doctor blade carrier, in which the doctor blade is pivotably fixed to the pressure cylinders about a longitudinal direction of the movement direction of the doctor blade during printing, and further in which at least one of the pressure cylinders and a control for supplying the pressure cylinders is dimensioned such that a change in the pressure acting on the pressure cylinders of one bar brings about a maximum change to the doctor blade force of 2.5 N/cm.

14. The device according to claim 13, wherein the maximum change to the pressure is 1.8 N/cm.

15. The device according to claim 13, wherein the doctor blade is made from a flexible rubbery material strip with a Shore hardness of less than 65 inclined relative to the printing screen.

16. The device according to claim 13, wherein a screen spacing (R) of the printing screen is at least 150 mm on all sides and the tension of the printing screen is equal to or below 25 N/cm.

17. The device according to claim 14, wherein a screen spacing (R) of the printing screen is at least 150 mm on all sides and the tension of the printing screen is equal to or below 25 N/cm.

18. The device according to claim 15, wherein a screen spacing (R) of the printing screen is at least 150 mm on all sides and the tension of the printing screen is equal to or below 25 N/cm.
